(19) United States
(12) Patent Application Publication
(10) Pub. No.: US 2007/0210502 A1
(43) Pub. Date: Sep. 13, 2007

(54) Apparatus For Handling Rolled Material

(76) Inventors: Joseph E. Gamsky, Gillett, WI (US); Christopher A. Wynveen, Shawano, WI (US)

Correspondence Address: BOYLE FREDRICKSON S.C., 840 North Plankinton Avenue, MILWAUKEE, WI, 53203, US

(21) Appl. No.: 11/684,440

(22) Filed: Mar. 9, 2007

Related U.S. Application Data
(60) Provisional application No. 60/780,562, filed on Mar. 9, 2006.
(60) Provisional application No. 60/842,790, filed on Sep. 7, 2006.

(51) Int. Cl. B41F 13/64

(52) U.S. Cl. 270/10

(57) ABSTRACT

An apparatus for supplying web material to an image creation and cutting device, taking up processed material from the device, and physically supporting the device. In some embodiments, the apparatus includes a plurality of upright support structures, adjacent ones defining troughs therebetween. The apparatus can further have the image creation and cutting device pivotably mounted thereupon. Servomotors selectively drive the rolls such that a loop of predetermined length is maintained between each roll and the image creation and cutting device, while the image creation and cutting device processes the web material.

### CROSS REFERENCE TO RELATED APPLICATIONS

This application claims priority under 35 U.S.C. Section 119(e) to U.S. Provisional Appln. Ser. No. 60/780,562, filed Mar. 9, 2006, and to U.S. Provisional Appln. Ser. No. 60/842,790, filed Sep. 7, 2006, both of which are hereby expressly incorporated herein by reference.

### FIELD OF THE INVENTION

This invention relates generally to the handling of rolled materials and, in particular, to an apparatus for supplying web material to an image creation and cutting device that incorporates a take-up system for receiving the material processed by the device.

### BACKGROUND AND SUMMARY OF THE INVENTION

As is known, image creation and cutting systems are utilized in the printing industry to create and cut images into a sheet of web material. In operation, a roll of web material is placed on alignment rollers. An operator loops the sheet from the roll of web material toward the floor and into the image creation and cutting system. Thereafter, the drive rollers of the image creation and cutting system are locked down to capture the sheet. It is necessary to provide a loop in the sheet of web material at the input of the image creation and cutting system in order to allow the image creation and cutting system to push and pull the sheet of web material through the image creation and cutting system as the system cuts the sheet of web material. A take-up mechanism is provided at the output end of the image creation and cutting system. As such, the operator must also loop the sheet of web material exiting the image creation and cutting system toward the floor and onto the take-up mechanism. After the sheet of web material has been processed by the image creation and cutting system, the sheet of web material is captured on the take-up mechanism. Once the entire roll of web material is received on the take-up mechanism, the processed material is removed from the take-up mechanism and transported to another location within a factory for further processing.

While functional, these prior image creation and cutting systems have certain limitations. More specifically, due to size restraints, these prior image creation and cutting systems accommodate web material rolls of minimal size. As a result, large printing and cutting runs require the operator to load and remove a plurality of rolls of web material onto and off of the image creation and cutting system. This, in turn, increases the time and costs associated with large printing and cutting runs. In addition, no present device exists for transporting, loading, and removing enlarged rolls of web material for use with these prior image creation and cutting systems. Consequently, it is highly desirable to provide an apparatus for supplying enlarged rolls of web material to an image creation and cutting device that incorporates a take-up system for receiving the processed material.

Therefore, it is a primary object and feature of the present invention to provide an apparatus for supplying enlarged rolls of web material to an image creation and cutting system that incorporates a take-up system for receiving the processed material.

It is a still further object and feature of the present invention to provide an apparatus for supplying enlarged rolls of web material to an image creation and cutting system that allows for larger printing and cutting runs than prior systems, and improving the run characteristics of such prior systems.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1A is an isometric view of an apparatus in accordance with the present invention, taken at a first side thereof.

FIG. 1B is an isometric view of the apparatus of FIG. 1A, taken at a second side thereof;

FIG. 1C is an isometric view of a variant of the apparatus of FIG. 1A;

FIG. 2A is a side elevation of the apparatus of FIG. 1A;

FIG. 2B is a side elevation of the apparatus of FIG. 1C;

FIG. 3A is an end view of the apparatus of FIG. 1A;

FIG. 3B is an end view of the apparatus of FIG. 1C;

FIG. 4 is a top, plan, view of the apparatus of FIG. 1C;

FIG. 5 is an enlarged sectional view of the apparatus of FIG. 1 taken along line 5-5 of FIG. 1;

FIG. 6 is an isometric view of a material-handling cart for use with the apparatus of the present invention;

FIG. 7 is an isometric view of the material-handling cart of FIG. 6 having a roll of web material deposited thereon;

FIG. 8 is a partially exploded view of the material-handling cart of FIG. 6 having a roll of web material deposited thereon;

FIG. 9 is an isometric view of a material-handling cart for use with the apparatus of the present invention and a lift for lifting the roll of web material from the handling cart;

FIG. 10 is an isometric view showing the lift of FIG. 9 lifting the roll of web material from the handling cart;

FIG. 11 is an isometric view showing the lift of FIG. 9 depositing the roll of web material on the apparatus of the present invention;

FIG. 12 is a side elevational view showing the lift and the apparatus of the present invention;

FIG. 13 is an exploded isometric view of a first core assembly for rotatably supporting a roll of web material;

FIG. 14 is a side elevational view of the core assembly and the roll of web material of FIG. 13;

FIG. 15 is a cross-sectional view of the roll of web material taken along line 14-14 of FIG. 13;

FIG. 16 is an end view of the core assembly and roll of web material of FIG. 13;

FIG. 17 is an exploded isometric view of a second core assembly for rotatably supporting a roll of web material;

FIG. 18 is a schematic view of a control mechanism for the apparatus of FIGS. 1A-1C; and

FIG. 19 is a schematic view showing operation of the apparatus of FIG. 1A.

### DETAILED DESCRIPTION OF THE DRAWINGS

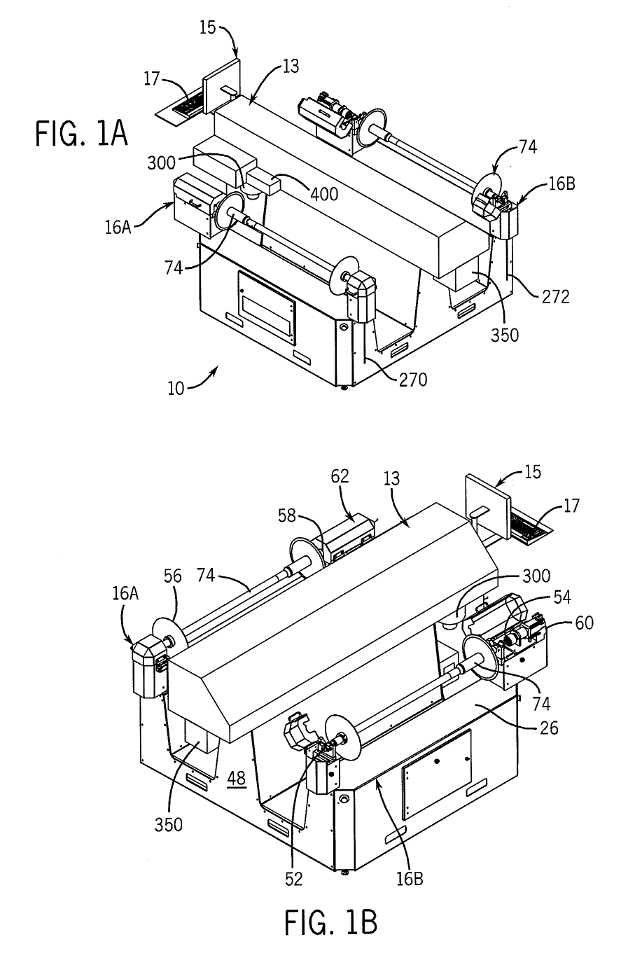

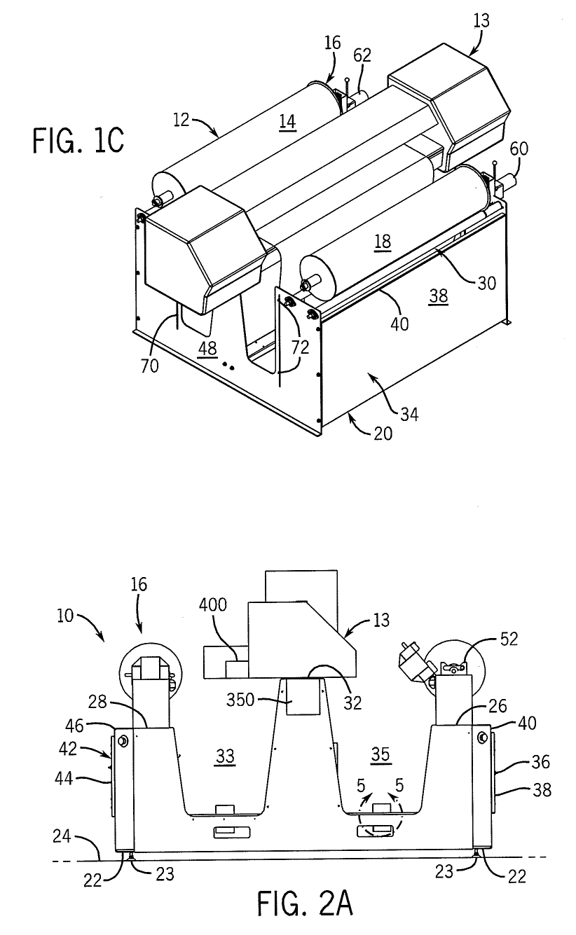

Referring to FIGS. 1A-4, an apparatus in accordance with the present invention is generally designated by the reference numeral 10. In general, apparatus 10 is adapted to support and hold, roll(s) 12 of web material 14 as well as support and hold an image creating and cutting device 13. The apparatus 10 also senses and monitors, for example, web position, web feed characteristics including web-travel velocity, movement, or other operating characteristics. In response to various ones such operating characteristics, it dynamically reacts to and manipulates or otherwise controls various components of the apparatus 10 to ensure desired overall use characteristics, explained in greater detail elsewhere herein.

In particular, it is intended for apparatus 10 to support a supply of roll 12 of web material 14, at a delivery mechanism 16A which is defined at one side of apparatus 10, and to deliver such web material 14 to image creation and cutting device 13. Apparatus 10, as hereinafter described, also incorporates a take-up mechanism 16B which is defined at the other side of apparatus 10, for receiving material 18 processed by image creation and cutting device 13 thereon.

By way of example, image creation and cutting device 13 may take the form of the image creation and cutting system disclosed in United States Patent Application Publication No. 2005/022559. However, other image creation and cutting systems may be used with apparatus 10 without deviating from the scope of the present invention. It is contemplated to operatively connect image creation and cutting device 13 to central processing unit (CPU) 15. CPU 15 includes an input device such as keyboard 17 to allow a user to program or otherwise control operation of image creation and cutting device 13.

Image creation and cutting device 13 is preferably a printer and cutter which has plot-cutting functionality, whereby it is adapted to pass a web of material such as web material 14, i.e., a printing substrate, through the device 13 in two opposing directions. As with many plot-cutting printers, image creation and cutting device 13 takes in a web of material while printing, by rotating its drive rollers in a first direction, then rotates its drive rollers in the opposite direction to output the material while dragging it over a knife or blade to make an elongate cut in the web material 14.

To support the image and cutting device 13, apparatus 10 includes base 20 having a bottom surface 22 with a plurality of leveling pads 23 projecting therefrom. It is intended for leveling pads 23 to be threadable into and out of bottom surface 22 of base 20 level the base 20 on supporting surface 24, such as a factory floor or the like.

Apparatus 10 further includes generally horizontal input land 26 for supporting roll 12 of web material 14; a generally horizontal output land 28 for supporting roll 30 of processed material 18; and central land 32 disposed between input and output lands 26 and 28, respectively, for supporting image creation and cutting device 13. It is intended that image creation and cutting device 13 be mounted on central land 32 of base 20 and affixed thereto in any suitable manner, such as by bolts or the like.

Referring specifically to FIGS. 1A, 1B, 2A, and 3A, although image creation and cutting device 13 is fixedly mounted to land 32, in some embodiments, land 32 is adapted and configured to move with respect to the remainder of base 20. In other words, in some embodiments, a first end of land 32 is pivotably connected to the main portion of base 20 by hinge 300. Hinge 300 is mounted vertically such that its axis of pivotation is vertically oriented, preferably generally under a drive motor portion of the image creation and cutting device 13.

The other, second, end of land 32 is connected to the remainder of base 20 by way of, e.g., an actuating mechanism such as actuator 350. The actuating piston or rod of actuator 350 either pushes the second end of land 32 away from itself or pulls it toward itself, corresponding to the particular signal it receives from, e.g., a suitable electronic controller. Accordingly, upon receiving a push-type signal, actuator 350 drives against and moves land 32 away from the actuator. In so doing, the first end of land 32 pivots upon hinge 300 and the second end of land 32 travels along an arcuate path with respect to hinge 300, in a first direction. Correspondingly, upon receiving a pull-type signal, actuator 350 pulls land 32 toward itself, whereby the first end of land 32 pivots upon hinge 300 and the second end of land 32 travels along an arcuate path in a second, opposite, direction. Optionally, in yet other embodiments, apparatus 10 has no land 32 whereby the image creation and cutting device 13 is mounted directly to hinge 300 and actuator 350, thus mounting it to base 20.

Input trough 33 is provided in base 20 between input land 26 and central land 32, for reasons hereinafter described. Similarly, output trough 35 is provided in base 20 between output land 28 and central land 32, for reasons hereafter described

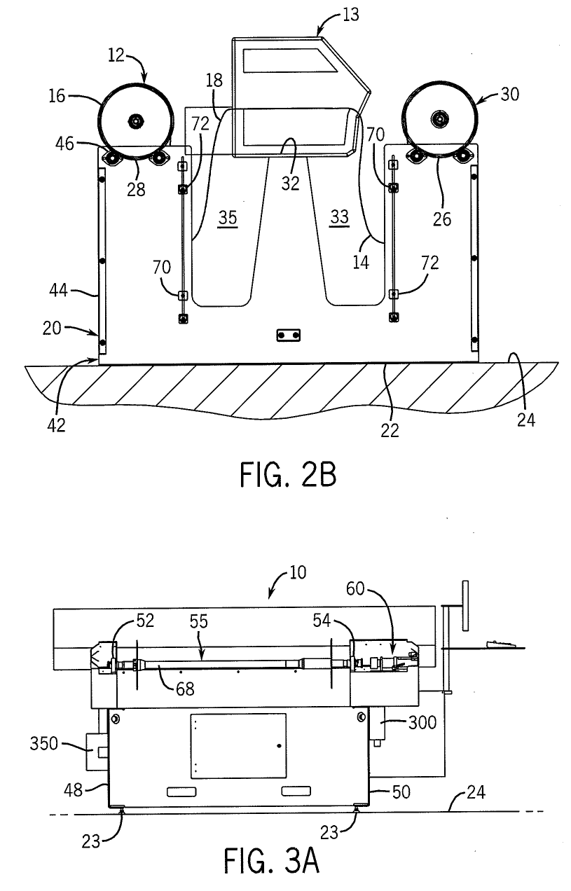

As best seen in FIGS. 2A and 2B, input land 26 is positioned adjacent first end 36 of base 20 and intersects end wall 38 at edge 40. Output land 28 is positioned adjacent second end 42 of base 20 and intersects end wall 44 at edge 46. End walls 38 and 44 are spaced and interconnected by sidewalls 48 and 50.

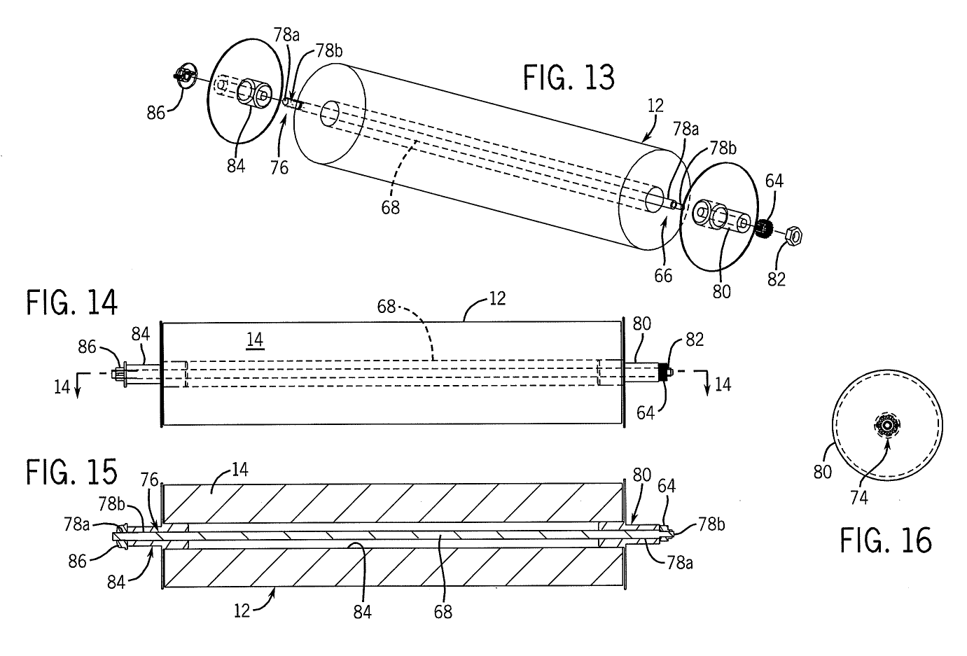

Referring to FIGS. 13-17, it is contemplated to support roll 12 of web material 14 and roll 30 of processed material 18, each of rolls 12 and 30 is mounted on a core assembly 74. It can be appreciated that, except as hereinafter provided, each core assembly 74 is identical in structure. As such, the following description of the mounting of core assembly 74 on core 84 of roll 12 of web material 14 is understood to describe the mounting of core assembly 74 on core 84 of roll 30 of processed material 18.

Regarding the specific components of cores 74, and referring now to FIGS. 13-16, in some embodiments, core assembly 74 includes central core support 68 having a first end 66 and a second end 76. It is intended for core support 68 to be inserted through core 84 of roll 12 of web material 14. Ends 66 and 76 of core support 68 include splined portions 78a and threaded portions 78b. First roller 80 and gear 64 are received on splined portions 78a of first end 66 of core support 68. Nut 82 is threaded onto threaded portion 78b of first end 66 of core support 68 in order to maintain first roller 80 and gear 64 thereon. Second roller 84 is received on splined portion 78a of second end 76 of core support 68. Locking collar 86 is positioned on threaded portion 78b of second end 76 of core support 68 to maintain second roller 84 thereon.

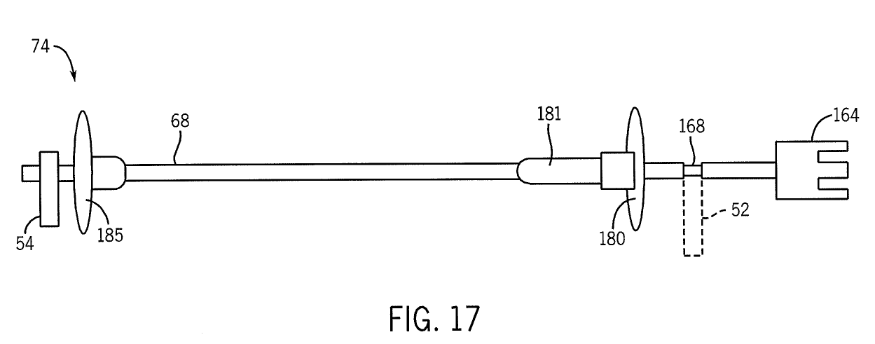

Referring to FIG. 17, in preferred embodiments, core assembly 74 includes relatively fewer components than those embodiments illustrated in FIGS. 13-16. In such embodiments, core support includes a reduced diameter portion proximate end 66, namely, channel 168. Channel 168 serves a registration and alignment function, mitigating the likelihood of core support 68 and thus the core assembly 74 from axially wandering in a non-desired fashion. The terminal-most portion of end 66 is attached to servomotor coupler 164, whereby rotation of the servomotor output shaft correspondingly rotates the core assembly 74.

Core assembly 74 of FIG. 17 further includes first and second roll holding sheaves or collars, i.e., collars 180 and 185, which are adjacent ends 66 and 76 of core support 68, respectively. The collars 180 and 185 interface with and hold the ends of rolls 12 and 30, holding then in axial registration along the core assembly 74. The particular axial location of collars 180 and 182 upon the core assembly 74 is determined by way of set screws.

Collar 180 further includes air bladder 181, which is, e.g., an elastomeric, expandable, pneumatic bag that extends concentrically around core support 68, and extends away from the inwardly facing surface of collar 180. In use, the air bladder 181 is inflated so that its outer surface compresses against and frictionally engages the inner circumferential surface of roll 12 or 30, i.e., the inside of core 84. The engaging relationship between bladders 181 and rolls 12 and 30 generally lock the rolls 12 and 30 in rotational unison with the core assembly 74, ensuring that when the servomotors 60 are energized, rolls 12 and 30 will correspondingly rotate.

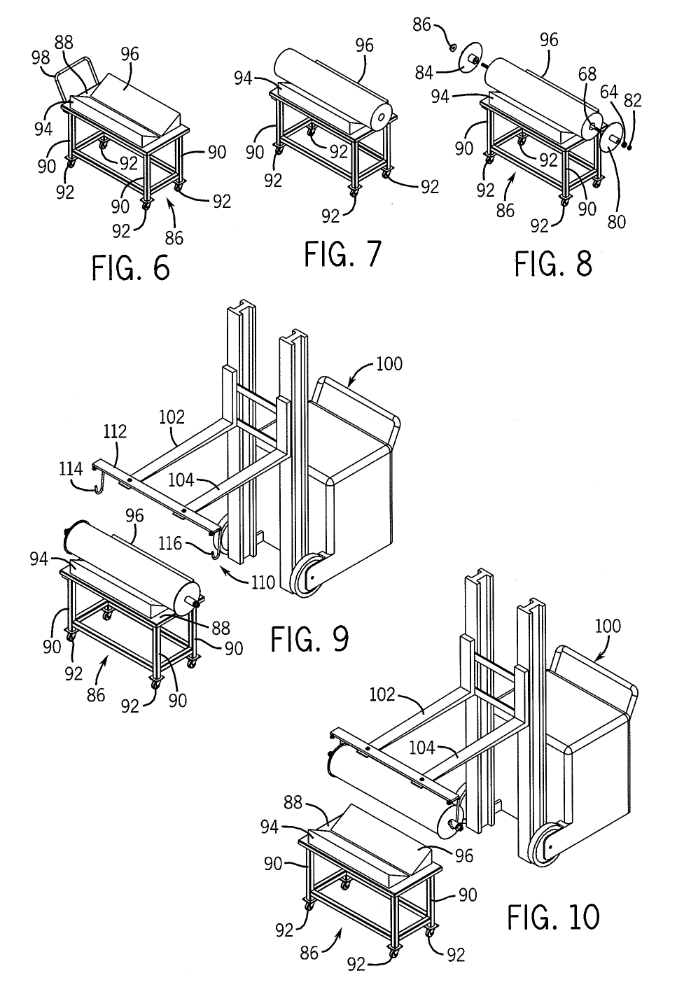

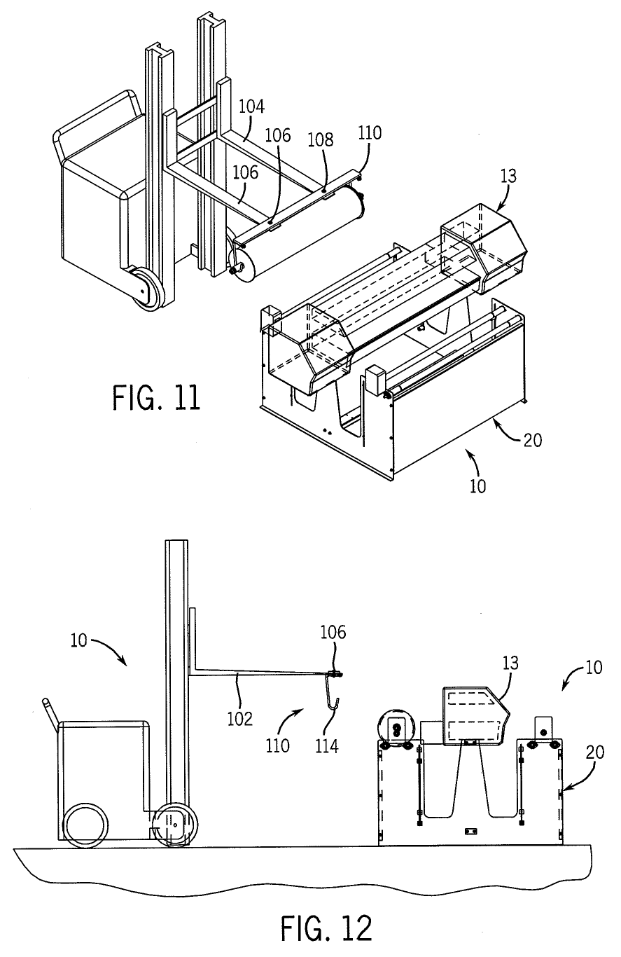

As illustrated in FIGS. 6-12, to use core assembly 74, it must first be inserted into, e.g., a roll 12 or 30. To facilitate mounting, e.g., roll 12 of web material 14 on core assembly 74, material-handling cart 86 is provided. It is intended for material-handling cart 86 to accommodate rolls of predetermined size and predetermined weight and to allow a single person to mount roll 12 of web material 14 on core assembly 74. Material-handling cart 86 may take the form of a table having a supporting surface 88 and a plurality of legs 90 depending therefrom. Each leg 90 terminates at a wheeled caster 92 to allow material-handling cart 86 to travel over supporting surface 24. First and second wedges 94 and 96, respectively, are positioned supporting surface 88 of material-handling cart 86 to support and maintain roll 12 of web material 14 thereon. Material-handling cart 86 may include removable handle 98 to allow for the easy loading of roll 12 thereon.

Once mounted upon cores 74, in order to move rolls 12 of web material 14 from material-handling cart 86 and transport them to apparatus 10, counterweight lift paper roll transportation device 100 is provided. Device 100 includes first and second forks 102 and 104, respectively, projecting therefrom. As is conventional, forks 102 and 104 are generally parallel and are movable between an elevated position and a lowered position. Holes extend through forks 102 and 104 and clevis pins 106 and 108 are installed in the openings in corresponding forks 102 and 104, respectively. Transport structure 110 is supported by forks 102 and 104. Transport structure 110 includes cross shaft 112 having first and second holes extending therein for receiving clevis pins 106 and 108. First and second hooks 114 and 116, respectively, depend from opposite ends of cross shaft 112. It is intended for hooks 114 and 116 to be adapted for supporting opposite ends 66 and 76 of core support 68, FIGS. 9-11.

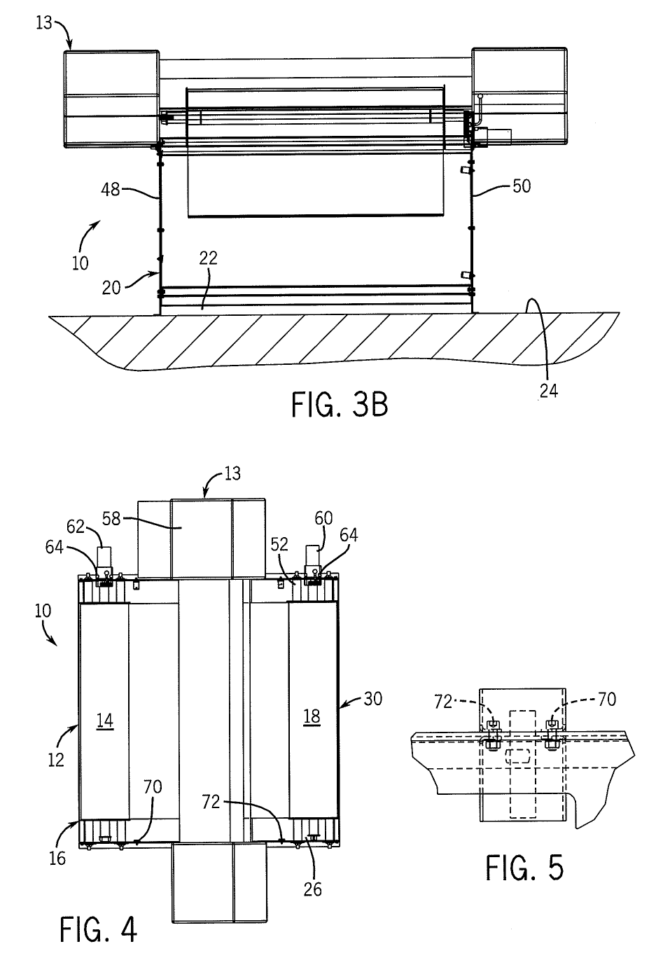

Accordingly, by utilizing device 100, rolls 12 and 30, once mounted to core assemblies 74, can be mounted to delivery mechanism 16A and take-up mechanism 16B in any of a variety of suitable ways. To provide the mounting interfaces upon which cores 74 are, e.g., rotatably mounted, apparatus 10 includes first and second roller assemblies 52 and 54, respectively, as in FIGS. 1A, 1B, 2A, and 3A. These roller assemblies 52 and 54 are positioned on opposite sides of land 26 between sidewalls 48 and 50 (FIGS. 2A, and 3A). Roller assemblies 52 and 54 are adapted to rotatably support opposite ends of first core assembly 74. Accordingly, roller assemblies 52 and 54 include a variety of bearings, bearing assemblies, or polymeric supports and guides such as the nylon journals which are illustrated as roller assemblies 52 and 54 in FIG. 16.

The nylon journal which defines assembly 52 in FIG. 17 has a thickness dimension which corresponds closely to, yet is slightly less in magnitude than, the width dimension of the channel 168 formed into support 68. In the entire assemblage, channel 168 sits and rolls upon the nylon roller assembly 52. The channel sidewalls, i.e., the annular surfaces which face each other at opposite sides of channel 168, straddle the roller assembly 52 and thereby hold the core assembly 74 in alignment and registration with the roller assembly 52.

Thus, in such embodiments, in order to mount roll 12 of web material 14 on apparatus 10, core support 68 of first core assembly 74 is inserted through the core of roll 12 of web material 14. Then, an operator positions roll 12 such that the ends of core assembly 74 are seated on corresponding roller assemblies 52 and 54. With roll 12 of web material 14 rotatably supported on roller assemblies 52 and 54, web material 14 is aligned with the input end of image creation and cutting device 13. This is done to ensure perfect registration between roll 12 of web material 14 and ultimately to take-up mechanism 16B.

Similarly, first and second roller assemblies 56 and 58, respectively, are positioned on opposite sides of output land 28 near sidewalls 48 and 50. Again, being analogous to assemblies 52 and 54, roller assemblies 56 and 58 are adapted to rotatably support opposite ends of a second core assembly 74, and include a variety, e.g., bearings or polymeric (preferably nylon) journals.

In some embodiments, such as those of FIGS. 1C, 2B, and 3B, in lieu of load-bearing journals or bearings, the mass of the rolls 12 and 30 is supported by pairs of elongate rollers upon which the rolls sit directly. In other words, in some embodiments, the operator positions roll 12 such that its outer periphery of web material is deposited onto a pair of elongate media rollers, illustrated as two parallel cylindrical members, parallel to the ground. With roll 12 of web material 14 received on elongate media rollers, web material 14 is aligned with alignment slots 59 and with image creation and cutting device 13. This is done to ensure perfect registration between roll 12 of web material 14 and take-up mechanism 16B. When roll 12 of web material 14 is properly aligned with alignment slots 59, gear 64 of core assembly 74 is aligned with the drive gears of a first servomotor 60 (FIG. 1A).

Regardless of the particular end configuration, apparatus 10 further includes a variety of electronic and electromechanical components which are adapted and configured to sense and monitor, for example, web position, web-travel velocity, web alignment, other web movement, or other operating characteristics, and respond to various ones such operating characteristics by dynamically reacting to and manipulating or otherwise controlling various components of the apparatus 10 to ensure desired operating characteristics.

Indeed, apparatus 10 in some respects can be largely considered a stand alone, distinct device from image creation and cutting device 13. Device 13 performs the primary functions (printing and cutting) and the remainder of apparatus 10 reacts, by controlling rolls 12 and 30, as well as the position of device 13 through pivot 300 and actuator 350, to ensure that device 13 is able to perform such primary functions in a suitable manner for a suitable length of time.

Generally, during operation of apparatus 10, the run-characteristics of web material 14 are sensed or monitored in a variety of ways at different locations within the apparatus 10. Ones of input and output sensor pairs 270 and 272, encoder 276, edge detector 400, and/or other suitable sensing or monitoring devices, detect web operating characteristic information, be it position, orientation, travel velocity, travel direction, or otherwise, and communicate such information to corresponding components of apparatus 10 to ensure desired use performance.

In particular, when roll 12 of web material 14 is properly aligned, web material 14 loops into input trough 33; past sensor pair 270; over encoder 276; under and past edge detector 400; and into image creation and cutting device 13. Web material 14 is fed through image creation and cutting device 13; into output trough 35; past sensor pair 272; and onto second core assembly 74 such that the processed web material 18 is maintained upon roll 30.

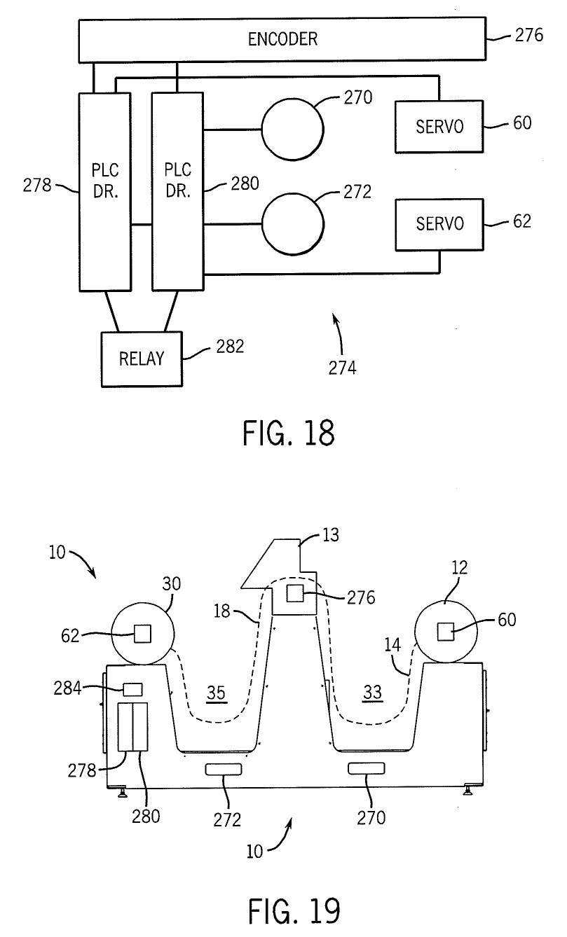

To rotate or otherwise control rolls 12 and 30, apparatus 10 includes, for example, first and second reversible electric servomotors 60 and 62, respectively. Referring to FIGS. 1A, 1B, 2A, 3A, 18, and 19, first servomotor 60 is positioned adjacent roller assembly 52 and housed with motor housing 61. First servomotor 60 includes drive gears adapted to mesh with a gear on a first end of first core assembly 74. Similarly, second servomotor 62 is positioned adjacent roller assembly 58 and housed within motor housing 63. Second servomotor 62 includes drive gears adapted to mesh with a gear on a first end of second core assembly 74 at the other end of apparatus 10. As best seen in FIGS. 18 and 19, input and output sensor pairs 270 and 272, communicate with servomotors 60 and 62 and are mounted to base 20 and directed toward corresponding troughs 33 and 35, respectively.

Input and output sensor pairs 270 and 272 sense the relative position of the loops of material 14 and 18 within the troughs 33 and 35. As best viewed in FIG. 19, the loops are defined by the downwardly free-hanging, sagging, or drooping arcuate portion of the web material 14 and 18, between the rolls 12 and 30, and the image creation and cutting device 13, respectively. Thus, generally, at no point during the traverse between the roll 12 and device 13, or between the device 13 and roll 30, is the web material 14 or 18 taut. This enables the material 14 and 18 to enter device 13 in a natural, relaxed fashion regardless of travel direction of material 14 and 18, i.e., whether it is advancing or regressing, forward or reverse.

Input and output sensor pairs, 270 and 272, sense the position or height of the loops and communicate such information to corresponding components, maintaining the loop heights, as desired. Such corresponding components include programmable logic controller (PLC) drives 278 and 280 and, as mentioned above, servomotors 60 and 62, respectively.

Accordingly, sensor pairs 270 and 272 sense the height of web material 14 in input trough 33 and the height of processed material 18 in output trough 35 and provide corresponding signals to PLC drives 78 and 80, respectively. Thereafter, PLC drives 278 and 280 send signals to servomotors 60 and 62, respectively. Most specifically, servomotor 60 rotates roll 12 to maintain the predetermined length of web material 14 in input trough 33, and servomotor 62 rotates roll 30 to maintain the predetermined length of processed material 18 in output trough 35.

Other factors influence the maintenance of loop height in apparatus 10. Typically, input and output sensor pairs 270 and 272 cooperate with encoder 276 to dynamically respond by, e.g., controlling servomotors 60 and 62, to the operation of image creation and cutting device 13. Encoder 276 detects, for example, which direction the web of material is traveling and the corresponding travel velocity.

This information, web travel direction and velocity, is transmitted to the PCL drives 278 and 280, which use yet other information from input and output sensor pairs 270 and 272, to make a rotational direction and speed determination for servomotors 60 and 62. Loop height information provided by input and output sensor pairs 270 and 272 are useful supplements to the web travel direction and speed information from encoder 276, since the actual speed of web material unrolled from or rolled upon rolls 12 and 18 is a function of not only the rotational speed of servomotors 60 and 62, but also the diameter of the respective rolls 12 and 18 at any given time, which influences the overall realized drive “gear ratio.”

Thus, during a period of use where the web material travels through the image creation and cutting device 13 at a constant velocity, the diameters of rolls 12 and 18 vary during such time, since they are unwinding and winding web material, respectively. Accordingly, the rotational speeds of servomotors 60 and 62 must also vary as a function of the rate of change of the roll diameters to ensure that the web material maintains the desired travel speed through device 13, while simultaneously maintaining the desired loop height.

Edge sensor 400 and actuator 350 cooperate to adjust the position of device 13 and ensure proper feed alignment of image creation and cutting device 13 with respect to the particular orientation run direction of web material 14 or 18 during use. Edge sensor 400 is typically mounted adjacent the input side of image creation and cutting device 13 and is preferably an analog photo-sensor which “looks down” upon the edge of the web material 14. For most operations of apparatus 10, it is desirable for web material 14 to enter the image creation and cutting device 13 at a substantially perpendicular angle. Thus, when it appears through edge sensor 400 that web material 14 is running out-of-square, actuator 350 reacts by pushing or pulling an end of image creation and cutting device 13 pivoting the device 13 upon hinge 300 until the web material 14 is again running in-square with respect to device 13. This adjustment and compensation is done dynamically while the web material 14 is running, i.e., during operation of apparatus 10.

In light of the above, to operate the device apparatus 10, the operator fist mounts roll 12 of web material 14 on the delivery mechanism 16A, then loops web material 14 into input trough 33 and into image creation and cutting device 13. The drive rollers of image creation and cutting device 13 are locked down the drive rollers of the printer. The operator then feeds material 14 through image creation and cutting device 13 toward take-up mechanism 16B, loops the web material into output trough 35, and mounts the web material to core 74 of roll 30.

Then, through CPU 15, the operator activates the apparatus 10. Upon so doing, the image creation and cutting device 13 processes web material 14 (i.e., prints on and cuts web material 14), whereby the image creation and cutting device 13 pushes and pulls web material 14 therethrough.

In response to the web material being pushed and pulled through the image creating and cutting device 13, in first and second opposing directions, the input and output sensor pairs 270 and 272, respectively, set and maintain the lengths of the loops in input and output troughs 33 and 35, respectively, to predetermined lengths determined by the size of the items to be printed and cut from web material 14 and the preference of the operator.

To maintain the predetermined loop length or height, and to accommodate the two directions of web movement through device 13, the encoder 274 senses web travel direction and velocity and transmits the sensed information to the PLC drives 278, 280. The PLC drives further use information from input and output sensor pairs 270 and 272 to determine the command to give servomotors 60 and 62. Thus, in response to how image creating and cutting device 13 is handling the web material 14, rolls 12 and 30 either wind or unwind, at appropriate rotational speeds, to maintain a sufficient amount of web material in the material loops within troughs 33 and 35.

All the while, edge detector 400, alone or in combination with actuator 350 or other components, evaluates whether the web material 14 is entering the image creating and cutting device 13 at the desired lateral input angle. To the extent the web lateral input angle deviates from the desired perpendicular angle, actuator 350 pivots the device 13 upon hinge 300 to mitigate the magnitude of such deviation.

When roll 30 of processed material 18 on take-up mechanism 16B is full, transportation device 100 may be used to remove roll 30 from take-up mechanism 16B and deposit the roll 30 on material handling cart 86. Roll 30 of processed material 18 may then be transported by the operator for further processing, as desired. Once roll 30 is deposited on material handling cart 86, core assembly 74 may be removed from core 84 of roll 30, inserted into a new roll 30 and reinstalled in take-up mechanism 16B. Likewise, core 74 can be removed from core 84 of roll 12. This core assembly 74 may then be used on a subsequent roll 12 of web material 14, as heretofore described, and the process is repeated. In the event of emergency situation, safety circuit 84 disconnects the power to PLC drives 278 and 280 to prevent further operation of apparatus 10.

Various modes of carrying out the invention are contemplated as being within the scope of the following claims particularly pointing out and distinctly claiming the subject matter that is regarded as the invention.

I claim:

1. An apparatus for supplying web material to an image creation and cutting device for processing the web of material comprising:
a) a first roll of web material for dispensing such web material to the image creation and cutting device;
b) a second roll, parallel to the first roll, for taking up the web material from the image creation and cutting device; and
c) a base structure upon which the image creation and cutting device is pivotably mounted.

2. The apparatus of claim 1 wherein the image creation and cutting device is pivotably mounted for pivoting about a generally vertical axis of pivotation.

3. The apparatus of claim 1 wherein at least one of the first and second rolls is mounted upon the base structure.

4. The apparatus of claim 1 further comprising a first support extending upwardly from the base for supporting a roll of web material.

5. The apparatus of claim 1 wherein the base structure is an upwardly extending support holding the image creation and cutting device.

6. The apparatus of claim 1 wherein each of the first and second rolls is mounted to the base structure.

7. The apparatus of claim 4 wherein each of the first roll, the second roll, and the image creation and cutting device, is mounted to a distinct upwardly extending support.

8. The apparatus of claim 4 wherein adjacent upwardly extending supports define a trough therebetween.

9. The apparatus of claim 1 wherein web material extends between the first roll and the image creation and cutting device in a free-hanging loop manner.

10. The apparatus of claim 1 wherein web material extends between the image creation and cutting device and the second roll in a free-hanging loop manner.

11. A method of printing using an image creation and cutting device that processes the web of material comprising:
a) providing a first roll for dispensing unprocessed web material and a second roll for taking up processed web material; and
b) feeding the unprocessed web material from the first roll to the image creation and cutting device and outputting the processed web material from the image creation and cutting device to the second roll; and
c) pushing and pulling the web material through the image creation and cutting device in first and second, opposite, directions; and
d) while pushing and pulling the web material through the image creation and cutting device, maintaining a predetermined length of web material, in a free-hanging manner, between one of the rolls and the image creation and cutting device.

12. The method of claim 11 wherein the web material is maintained at the predetermined length by rotating at least one of the rolls.

13. The method of claim 11 wherein the web material is maintained at the predetermined length by rotating both of the rolls simultaneously.

14. The method of claim 11 wherein the web material is maintained at the predetermined length by rotating both of the rolls at different rotational speeds.

15. The method of claim 11 wherein the image creation and cutting device is movably mounted to a base for movement during use.

16. The method of claim 15 wherein the image creation and cutting device is pivotably mounted.

17. The method of claim 15 wherein the image creation and cutting device is pivotably mounted and pivots about a generally vertical axis of pivotation.

18. The method of claim 15 wherein the method includes detecting information relating to an angle of entry of the web material into the image creations an cutting device.

19. The method of claim 11 wherein the method further includes providing a base with first and second upright supports for mounting one of the rolls and the image creation and cutting device upon the first and second upright supports defining a trough therebetween.

20. An apparatus for supplying web material to an image creation and cutting device that processes the web of material comprising:
a) a first support which supports a roll of web material;
b) a second support which movably supports the image creation and cutting device; and
c) a third support which supports a roll which receives processed web material.

21. The apparatus of claim 20 wherein the first and second supports define an input trough for receiving a predetermined length of web material therein.

22. The apparatus of claim 20 wherein the second and third supports define an output trough for receiving a predetermined length of processed material therein.

23. The apparatus of claim 20 further comprising a control mechanism for controlling processing of the web material.

24. The apparatus of claim 20 wherein the image creation and cutting device is pivotably mounted to the second support.

25. The apparatus of claim 24 wherein the image creation and cutting device pivots about a generally vertical axis of pivotation.
